(19) United States
(12) Patent Application Publication
(10) Pub. No.: US 2015/0074614 A1
(43) Pub. Date: Mar. 12, 2015

(54) DIRECTIONAL CONTROL USING A TOUCH SENSITIVE DEVICE

(71) Applicants: Mark Leroy Walker, Castaic, CA (US); Bruce Douglas Johnson, West Hills, CA (US)

(72) Inventors: Mark Leroy Walker, Castaic, CA (US); Bruce Douglas Johnson, West Hills, CA (US)

(73) Assignee: THOMSON LICENSING, Issy de Moulineaux (FR)

(21) Appl. No.: 14/373,909

(22) PCT Filed: Jan. 25, 2012
(86) PCT No.: PCT/US2012/022520

§ 371 Date: Jul. 23, 2014

(51) Int. Cl. G06F 3/0488; G06F 3/0484

(52) U.S. Cl. CPC G06F 3/04883; G06F 3/04842
USPC 715/863

(57) ABSTRACT

A method and system for navigation within a two-dimensional grid object displayed on an electronic device includes determining a starting location and a circular motion of a touch gesture on the touch sensitive interface. Advancement of the circular motion of the touch gesture is mapped into a continuous navigation along an axis of the displayed grid object. The mapping into a navigation direction within the grid object is based on the starting location and the circular direction of the touch gesture. The results of the navigation, such as an indication of navigation direction and a location within the grid object are displayed.

### FIELD

The present invention relates to the field of user interfaces, and in particular, is related to X and Y coordinate control using circular gestures on a touch sensitive interface of an electronic device.

### BACKGROUND

Touch pad devices provide a user with a touch sensitive interface to navigate and control functions of an electronic device. A touch pad can be any touch sensitive interface that accepts circular touch gestures for control and navigation of electronic devices requiring a human interface. One form of a touch sensitive device includes a touch wheel that can generally sense the touch of a finger performing a circular motion around the circular form of the touch wheel and translates the circular motion to a scrolling action for a display on the electronic device. Tools may also be used instead of human digits according to the technology used by the touch wheel device. Touch wheels can function via resistive, capacitive, or other touch sensitive characteristics as understood by those of skill in the art. One example of a touch wheel device is that used in a portable media player such as the click wheel of an iPod® device available through Apple® Incorporated of Cupertino Calif., USA.

Touch wheel devices can be used to navigate a list of items that can be displayed as a one-dimensional linear list. By moving a finger or other tool, the user can activate the touch sensitive characteristic of the touch wheel and the movement can be interpreted by the electronic device as a navigation command to scroll forward or back through the one-dimensional linear list. Thus, a user can scroll though a single axis (one-dimensional) list of items in sequence to select a desired item. One example of such single axis navigation is the user's selection of a song or video that is desired to be rendered on a portable media player. A user may move forward or backward in the one-dimensional list using a clockwise or counterclockwise circular motion on the touch wheel. However, touch wheel interfaces have not been used as a navigation device for two-dimensional lists such as a matrix or on an X and Y coordinate data item such as a picture or plot. Also, more generally, a touch pad, commonly used on laptop computers, does not accommodate the use of circular touch gestures to navigate either one dimensional lists or two-dimensional grid objects.

### SUMMARY

This summary is provided to introduce a selection of concepts in a simplified form that are further described below in the Detailed Description. The Summary is not intended to identify key features or essential features of the claimed subject matter, not is it intended to be used to limit the scope of the claimed subject matter.

This invention provides a method for two-dimensional navigation within a two-dimensional grid object that can be displayed on an electronic device. The invention uses a touch sensitive interface that interprets a starting location of a circular touch gesture that is mapped to one navigation axis of the two-dimensional grid object. A second touch gesture on the touch sensitive interface can be used to navigate in the other navigation axis of the two-dimensional grid object. The results of the mapping of the circular gesture to an axis of the grid object are displayed to allow interactive two-axis navigation.

Additional features and advantages of the invention will be made apparent from the following detailed description of illustrative embodiments which proceeds with reference to the accompanying figures.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 illustrates an example operation of the invention to navigate in a +X direction according to one embodiment;

FIG. 2 illustrates an example operation of the invention to navigate in a −X direction according to one embodiment;

FIG. 3 illustrates an example operation of the invention to navigate in a +Y direction according to one embodiment;

FIG. 4 illustrates an example operation of the invention to navigate in a −Y direction according to one embodiment;

FIG. 5 illustrates an example operation of the invention to navigate in a +X direction according to a second embodiment;

FIG. 6 illustrates an example operation of the invention to navigate in a −X direction according to a second embodiment;

FIG. 7 illustrates an example operation of the invention to navigate in a −Y direction according to a second embodiment;

FIG. 8 illustrates an example operation of the invention to navigate in a +Y direction according to a second embodiment;

FIG. 9 illustrates an example method of operation common to the first and second embodiment of the invention;

FIG. 10 illustrates an example method of operation common according to a first embodiment of the invention;

FIG. 11 illustrates an example method of operation common according to a second embodiment of the invention; and

FIGS. 12a, 12b, and 12c depict example apparatus features of the invention.

### DETAILED DISCUSSION OF THE EMBODIMENTS

In the following description of various illustrative embodiments, reference is made to the accompanying drawings, which form a part thereof, and in which is shown, by way of illustration, various embodiments in the invention may be practiced. It is to be understood that other embodiments may be utilized and structural and functional modification may be made without departing from the scope of the present invention.

Touch-based user interface controls, also known as touch sensitive interfaces, (e.g. touch screens, touch pads, touch wheels) typically use touch gestures to move through lists of items. The predominant mechanisms for navigating long lists of items appears to involve repetitive, yet distinct, strokes to “page” through the data and/or the use of a separate scroll bar control for course navigation through a list of items. In either of these cases, multiple gestures or a mode-switch (changing the control being used) is required to facilitate the navigation of long lists of items.

The invention described herein describes an alternative and possibly more efficient way to scroll through long lists of items using a circular gesture on a touch pad, touch screen, and the like. The invention is also especially suited to scrolling or navigating through a grid object, such as a displayed two-dimensional object. Such grid objects include cell-based application such as a matrix, a table, a spreadsheet, a graph, a text document, or a picture displayed on the electronic device. For purposes of this invention, a grid object is a two-dimensional object that can be displayed such that navigation through or across the object can be accomplished by moving in an X direction or a Y direction or both to arrive at a data point, cell, or location within the grid. Such a data point may be a cell of information within a table or spreadsheet, a point on or near a graph, one or more pixels in a picture, or one or more locations of words in a text document. Thus, a grid object is not limited to a matrix type of object, but instead is inclusive of any displayed object that can be displayed such that the object has two-dimensional features. Non-exhaustive and non-limiting examples of two-dimensional features include length and width, height and breadth, magnitude and direction, magnitude and time, X and Y coordinates, Y and Z coordinates, vertical and horizontal, etc.

According to aspects of the invention, by using a circular touch gesture, navigation in any given direction can be achieved with a single continuous motion. In one embodiment, establishing the direction to scroll along an axis of information within a grid object begins by identifying the relative starting point of the touch gesture to determine the mapping of touch gesture circular or rotational motion to linear direction within the grid object. Navigation along one axis of the grid object is equivalent to moving along the information contained in that axis of navigation of the grid object. For example, navigation along an X Axis of a spreadsheet grid object is navigation along the row of the spreadsheet. Navigation along the Y axis of a spreadsheet is navigation along a column of a spreadsheet. In another example, navigation along ax X axis of a graph to where the plotted graph curve is intersected provides the value of the X coordinate of the curve on the plotted graph.

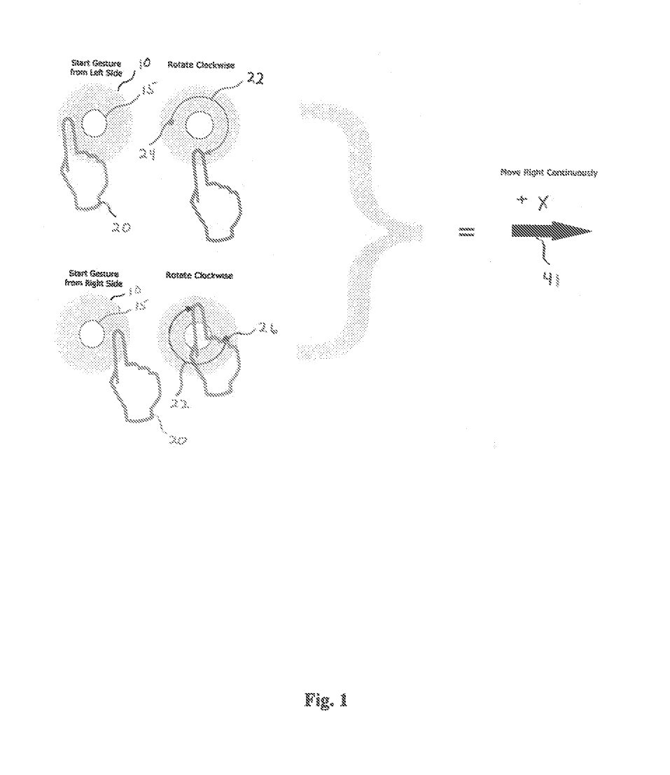

FIGS. 1-4 depict one embodiment of the invention. Each of the figures includes a touch sensitive device 10 and a touching device 20. The touch sensitive device can be any touch sensitive device known to those of skill in the art and include a touch pad, such as found on a standard or notebook or pad-type laptop device, PC keyboard or other PC peripheral device, PDA, cell phone, test equipment, media players, or other electronic devices. A touch wheel is another form of a touch sensitive device known to those of skill in the art and include a touch wheel or click wheel as may be present on PDAs, cell phones, test equipment, media players, such as iPods®, or other electronic devices. Although a hand and finger or thumb is shown as touching device in FIGS. 1-4, one of skill in the art understands that a substitute touching device may be used, such as a stylus or other pointing device, to activate the touch sensitive device depending on the technology used for the touch sensitive device. In FIGS. 1-4, the result of the touch gesture is shown symbolically to the right as an arrow indicating relative direction, horizontal (+/−X) or vertical (+/−Y), of movement within an object displayed on an electronic device. Thus, for example, FIG. 1 describes the user interface touch gestures needed for a +X or rightward direction movement within a displayed grid object. Such a movement can be expected to be a continuous direction movement within the displayed object corresponding to a continuous touch gesture movement in a particular direction. An electronic device that displays the grid object can be any device, but need not be the same device that includes the touch sensitive interface. For example, the current invention may be embodied in a laptop or tablet computer which has a display and uses a touch sensitive device such as a touch sensitive screen or touch pad. Additionally, the current invention may be embodied, for example, in a remote control device that does not have a display but controls another electronic device which does control or include a display, Non limiting examples include television remote controls, Set-top box remote controls, DVD remote controls, and test equipment remote controls.

FIGS. 1-4 depict one embodiment of the invention which relies on the initial touch position or location on the touch sensitive interface 10 relative to the center 15 of the circular touch gesture to determine the axis of movement within the displayed grid object. The axis of movement within the grid object may be, for example, an X (left or right) axis or a Y (up and down) axis. The direction of movement within the grid object is determined based on the particular rotational (circular) direction of the touch gesture on the touch sensitive interface.

FIG. 1 depicts a touch gesture which results in a rightward direction or +X directional navigation in a displayed grid object. In FIG. 1, when the initial touch gesture starting location is to the left 24 or to the right (26) of the center 15 of the circular touch gesture, then the axis of movement within the grid object is horizontal (in the X axis). If advancement (continuation) of the touch gesture rotation is in a clockwise 22 (CW) direction, then the direction of movement within the grid object is horizontally to the right or in the +X axis direction 41. Thus, starting location 24 or 26 in FIG. 1, coupled with advancement of the touch gesture in a clockwise rotation direction 22, results in a +X direction 41 movement in a displayed grid object.

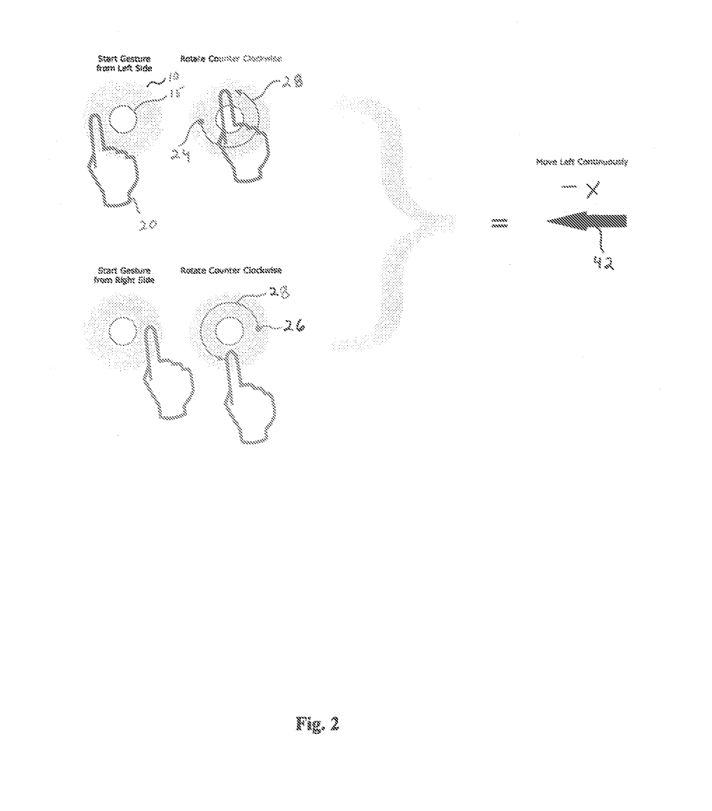

FIG. 2 depicts a touch gesture which results in a leftward direction or +X directional navigation in a displayed grid object. In FIG. 2, when the initial touch gesture starting location is to the left 24 or to the right 26 of the center 15 of the circular touch gesture, then the axis of movement within the grid object is horizontal (in the X axis). If advancement of the touch gesture rotation is in a counterclockwise 28 (CW) direction, then the direction of movement within the grid object is horizontally to the left or in the −X axis direction 42. Thus, starting location 24 or 26 in FIG. 2, coupled with advancement of the touch gesture in a counterclockwise rotation direction 28, results in a −X direction 42 movement in a displayed grid object.

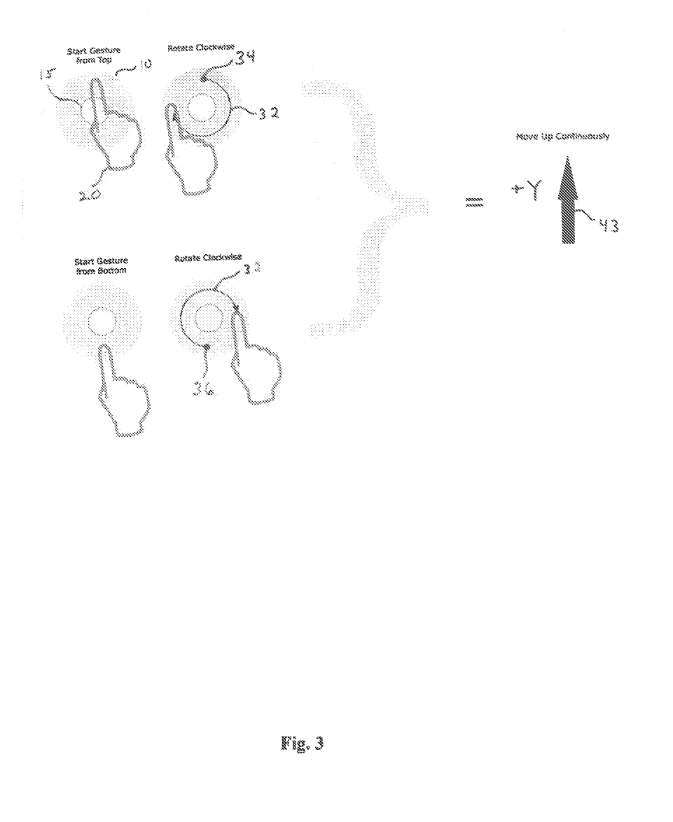

FIG. 3 depicts a touch gesture which results in an upward direction or +Y directional navigation in a displayed grid object. In FIG. 3, when the initial touch gesture starting location is in a top 34 or to the bottom 36 of the center 15 of the circular touch gesture, then the axis of movement within the grid object is vertical (in the Y axis). If advancement of the touch gesture rotation is in a clockwise 32 (CW) direction, then the direction of movement within the grid object is vertically in the up direction or in the +Y axis direction 43. Thus, starting location 34 or 36 in FIG. 3, coupled with advancement of the touch gesture in a clockwise rotation direction 38, results in a +Y direction 43 movement in a displayed grid object.

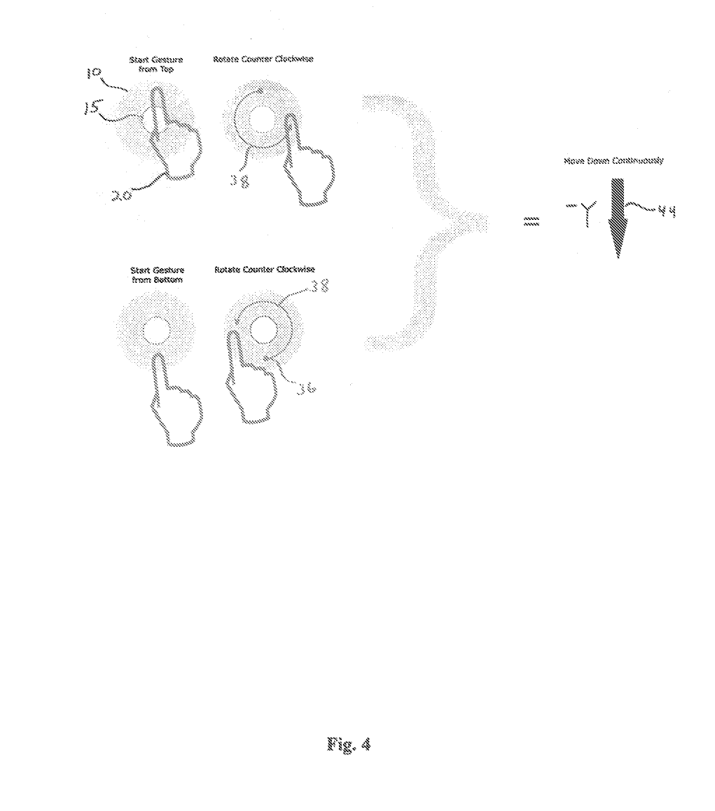

FIG. 4 depicts a touch gesture which results in a downward direction or −Y directional navigation in a displayed grid object. In FIG. 4, when the initial touch gesture starting location is in a top 34 or to the bottom 36 of the center 15 of the circular touch gesture, then the axis of movement within the grid object is vertical (in the Y axis). If advancement of the touch gesture rotation is in a counterclockwise 38 (CW) direction, then the direction of movement within the grid object is vertically in the down direction or in the −Y axis direction 44. Thus, starting location 34 or 36 in FIG. 4, coupled with advancement of the touch gesture in a counterclockwise rotation direction 38, results in a −Y direction 44 movement in a displayed grid object.

In FIGS. 1-4, direction reversal of movement within the grid object may be achieved by simply reversing the motion of the circular touch gesture from a clockwise to a counterclockwise movement. For example, in FIG. 1, once the +X direction of movement has been established in the grid object by using the clockwise movement of the touch gesture, a reversal of the touch gesture to a counterclockwise direction will result in a movement in the −X direction in the grid object. The pointing or touching device should remain in contact with the touch sensitive device for a direction reversal to occur.

Likewise in FIG. 2, after establishing a movement in the grid object of the −X direction using a counterclockwise touch gesture movement, a reversal of the touch gesture to a clockwise motion will result in a movement in the +X direction in the grid object. In FIG. 3, after establishing a movement in the grid object of the +Y direction using a clockwise touch gesture movement, a reversal of the touch gesture to a counterclockwise motion will result in a movement in the −Y direction in the grid object. In FIG. 4, after establishing a movement in the grid object of the −Y direction using a counterclockwise touch gesture movement, a reversal of the touch gesture to a clockwise motion will result in a movement in the +Y direction in the grid object.

Using the first embodiment of the invention shown in FIGS. 1-4, navigation in both an X and Y axis in the grid object may be obtained. One example method to accomplish navigation in a first direction followed by navigation in a second direction may be expressed by using two touch gestures as follows. A method to navigate in an X axis and a Y axis of a two-dimensional object displayed on an electronic device includes initiating a first touch gesture at either a top position or a bottom position on the touch sensitive interface and advancing the first touch gesture in a clockwise motion on the touch sensitive interface to navigate in an upward (+Y) direction within the two-dimensional grid object. It is noted that subsequently advancing the touch gesture in a counterclockwise motion on the touch sensitive interface navigates in a downward (−Y) direction within the two-dimensional grid object.

To subsequently navigate in the other axis, a second touch gesture is initiated at either a left position or a right position on the touch sensitive interface. The second touch gesture advances in a clockwise motion on the touch sensitive interface to navigate in a rightward (+X) direction within the two-dimensional grid object. It is noted that subsequently advancing the second touch gesture in a counterclockwise motion on the touch sensitive interface navigates in a leftward (−X) direction within the two-dimensional grid object. Thus, navigation in a first axis and subsequent navigation in a second axis can be accomplished using the aspects of the invention.

As a variant to the purely or strictly clockwise or counter clockwise movements depicted in FIGS. 1-4, a linear gesture movement (not shown) may be used to establish the initial navigation direction. For example, a continuous but initially linear movement, instead of an initial strictly clockwise or counter clockwise movement, may be used in continuous conjunction with a circular movement to establish the initial direction. Once a clockwise or counterclockwise gesture is detected, then that particular rotational direction is mapped to the same direction as the initial linear gesture. For example, in FIG. 1, a linear gesture from location 24 moving left to right can initially establish the +X direction. Subsequently if the gesture continues in a clockwise manner, the navigation continues in the +X direction established by the initial linear movement. Thus, the use of a circular gesture after an initial linear gesture allows unlimited continuous navigation to occur in the selected direction without stopping. Normally, a touch pad or touch screen would limit continuous navigation in a single direction because the edge of the touch pad or touch screen would be reached. The invention provides for continuous navigation in the selected direction without stopping because of the use of the circular gesture. In any of the above embodiments, a minor deviation from an initial linear gesture is tolerated to avoid over-reacting to small variances in an otherwise initial linear gesture. Likewise, some minor deviation from a circular gesture is tolerated to avoid over-reacting to small variances in an otherwise circular gesture.

In addition to navigation in a two-dimensional grid object as described above with respect to FIGS. 1-4, the invention may also be used to navigate in a one dimensional list using circular gestures on a touch pad or touch screen device. Normally, navigation in a one dimensional list using a touch pad device is conducted using linear only gestures. The invention expands navigation in a list to include circular gestures on a touch pad or touch screen device.

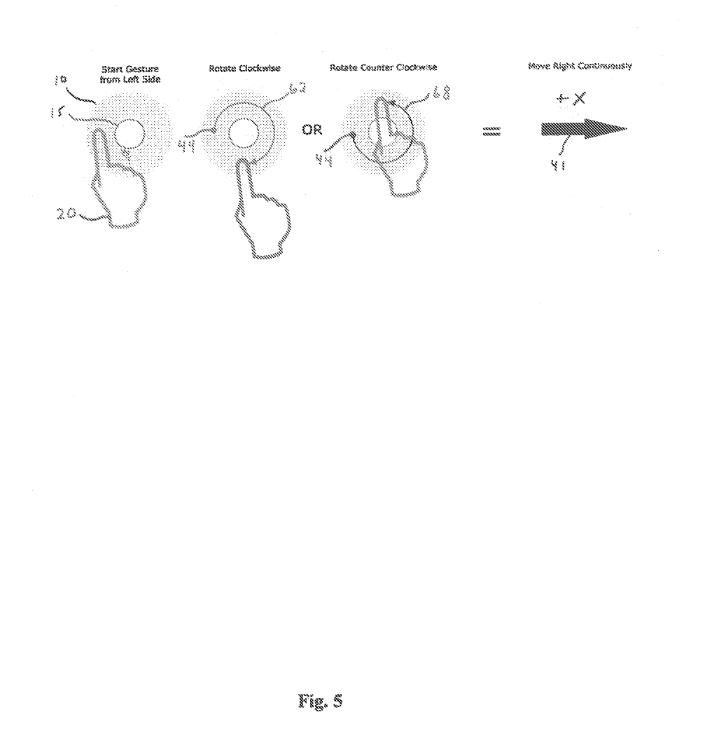

FIGS. 5-8 depict a second embodiment of the invention. Numbering with respect to the touch sensitive interface items are similar to those used in FIGS. 1-4. In FIGS. 5-8, the clockwise or counter-clockwise rotation may be ignored when determining navigation direction within the grid object as long as a circular motion is initially started. The navigation direction is determined by the initial touch point relative to the center of the circular touch gesture on the touch sensitive interface. The clockwise or counter-clockwise motion of the touch gesture is detected and established as the primary or initial rotational motion of the touch gesture. The initial rotational motion of the touch gesture is mapped into the navigation direction for the grid object. Reversing the touch gesture's circular motion (from clockwise to counterclockwise or vice versa) reverses the navigation direction mapped onto the grid object that is displayed.

FIG. 5 depicts a touch gesture on the touch sensitive interface which results in a rightward (+X) navigation direction within the grid object. In FIG. 5, a left touch point starting location 44 is used indicating as that the X or horizontal axis of the navigation direction within the grid object will be used. A circular gesture either clockwise 62 or counterclockwise 68 then begins the movement of a +X navigation direction within the grid object. In another aspect of the invention example of FIG. 5, if the circular gesture then subsequently changes, for example, moves from a clockwise motion to a counterclockwise motion after the +X navigation direction is started, then the navigation direction would be reversed from a +X navigation direction to a −X navigation direction within the grid object. For a navigation direction to be reversed, the circular touch gesture should remain uninterrupted. That is, a continuous touching of the touch sensitive interface surface is required.

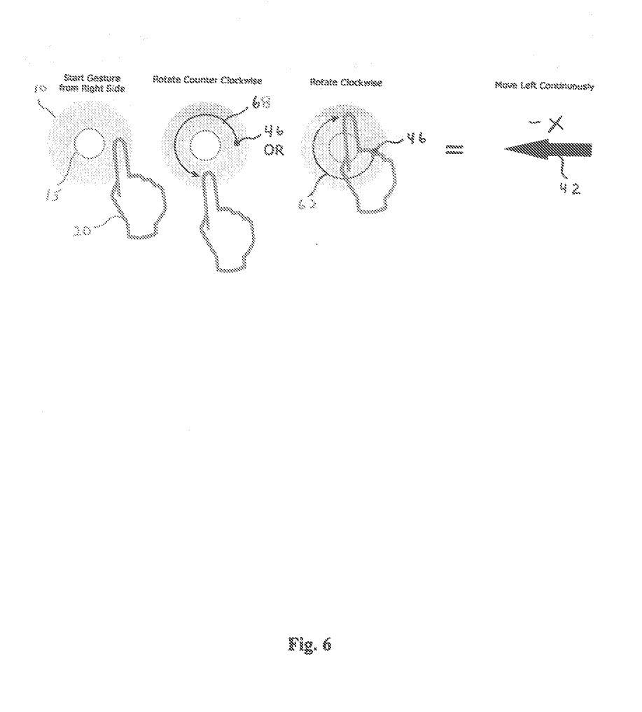

FIG. 6 depicts a touch gesture on the touch sensitive interface which results in a leftward (−X) navigation direction within the grid object. In FIG. 6, a right touch point starting location 46 is used indicating that the X axis or horizontal axis of the navigation direction within the grid object will be used. A circular gesture either clockwise 62 or counterclockwise 68 then begins the movement of a −X navigation direction within the grid object. In another aspect of the invention example of FIG. 6, if the circular gesture then subsequently changes, for example, moves from a clockwise motion to a counterclockwise motion after the −X navigation direction is started, then the navigation direction would be reversed from a −X navigation direction to a +X navigation direction within the grid object. For a navigation direction to be reversed, the circular touch gesture should remain uninterrupted. That is, a continuous touching of the touch sensitive interface surface is required.

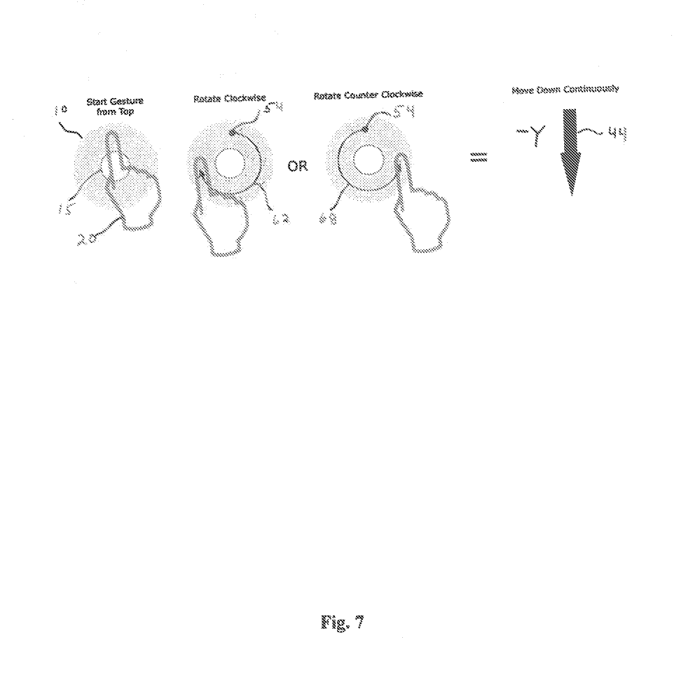

FIG. 7 depicts a touch gesture on the touch sensitive interface which results in a downward (−Y) navigation direction within the grid object. In FIG. 7, a top touch point starting location 54 is used indicating that the Y axis or vertical axis of the navigation direction within the grid object will be used. A circular gesture either clockwise 62 or counterclockwise 68 then begins the movement of a −Y navigation direction within the grid object. In another aspect of the invention example of FIG. 7, if the circular gesture then subsequently changes, for example, moves from a clockwise motion to a counterclockwise motion after the −Y navigation direction is started, then the navigation direction would be reversed from a −Y navigation direction to a +Y navigation direction within the grid object. For a navigation direction to be reversed, the circular touch gesture should remain uninterrupted. That is, a continuous touching of the touch sensitive interface surface is required.

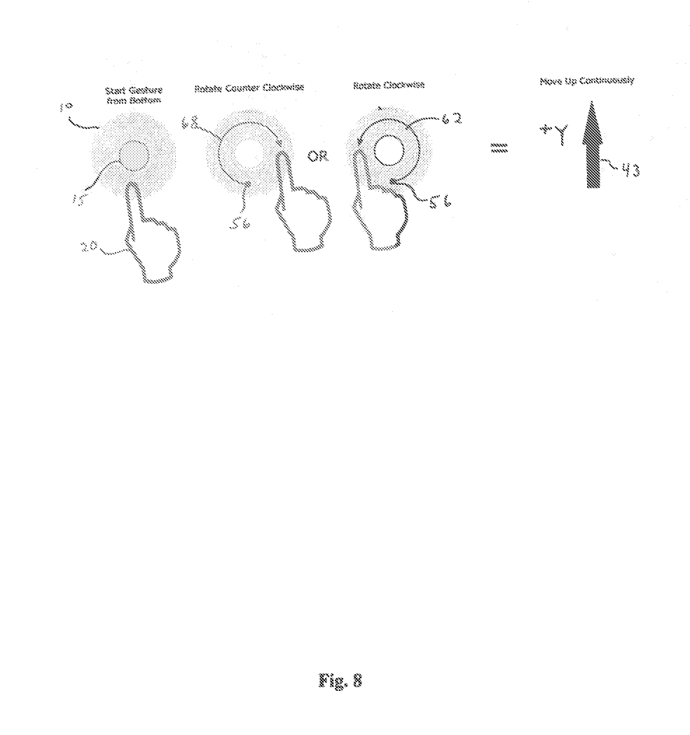

FIG. 8 depicts a touch gesture on the touch sensitive interface which results in an upward (+Y) navigation direction within the grid object. In FIG. 8, a bottom touch point starting location 56 is used indicating that the Y axis or vertical axis of the navigation direction within the grid object will be used. A circular gesture either clockwise 62 or counterclockwise 68 then begins the movement of a +Y navigation direction within the grid object. In another aspect of the invention example of FIG. 8, if the circular gesture then subsequently changes, for example, moves from a clockwise motion to a counterclockwise motion after the +Y navigation direction is started, then the navigation direction would be reversed from a +Y navigation direction to a −Y navigation direction within the grid object. For a navigation direction to be reversed, the circular touch gesture should remain uninterrupted. That is, a continuous touching of the touch sensitive interface surface is required.

Using the second embodiment of the invention shown in FIGS. 5-8, navigation in both an X and Y axis in the grid object may be obtained. One example method to accomplish navigation in a first direction followed by navigation in a second direction may be expressed by using two touch gestures as follows. A method to navigate in an X axis and a Y axis of a two-dimensional object displayed on an electronic device includes initiating a first touch gesture at a top position on the touch sensitive interface and advancing the first touch gesture in either a clockwise or a counterclockwise motion on the touch sensitive interface to navigate in a downward (−Y) direction within the two-dimensional grid object. Alternately, to initiate navigation along the Y axis in a +Y direction, the first touch gesture can be initiated at a bottom position on the touch sensitive interface and advancing the first touch gesture in either a clockwise or a counterclockwise motion on the touch sensitive interface to navigate in an upward (+Y) direction within the two-dimensional object. Using either a top or bottom starting location relative to the center of the circular gesture, once a navigation direction is selected along the Y axis, a reversal of circular gesture results in a reversal of direction of navigation in the grid object.

As a variant to the purely or strictly clock wise or counter clockwise movements depicted in FIGS. 5-8, a linear gesture movement (not shown) may be used to establish the initial navigation direction. As expressed for FIGS. 1-4, a continuous but initially linear movement, instead of an initial strictly clockwise or counter clockwise movement, may be used in continuous conjunction with a circular movement to establish the initial direction. Once a clockwise or counterclockwise gesture is detected, then that particular rotational direction is mapped to the same direction as the initial linear gesture. For example, in FIG. 5, a linear gesture from location 44 moving left to right can initially establish the +X direction. Subsequently if the gesture continues in a clockwise or counterclockwise motion, the navigation continues in the +X direction established by the initial linear movement. Thus, the use of a circular gesture after an initial linear gesture allows unlimited continuous navigation to occur in the selected direction without stopping. Normally, a touch pad or touch screen would limit continuous navigation in a single direction because the edge of the touch pad or touch screen would be reached. The invention provides for continuous navigation in the selected direction without stopping because of the use of the circular gesture. In any of the above embodiments, a minor deviation from an initial linear gesture is tolerated to avoid over-reacting to small variances in an otherwise initial linear gesture. Likewise, some minor deviation from a circular gesture is tolerated to avoid over-reacting to small variances in an otherwise circular gesture.

In addition to navigation in a two-dimensional grid object as described above with respect to FIGS. 5-8, the invention may also be used to navigate in a one dimensional list using circular gestures on a touch pad or touch screen device. Normally, navigation in a one dimensional list using a touch pad device is conducted using linear only gestures. The invention expands navigation in a list to include circular gestures on a touch pad or touch screen device.

To subsequently navigate in the other axis of the grid object, a second touch gesture is initiated at a left position on the touch sensitive interface and advancing the second touch gesture in either a clockwise or a counterclockwise motion on the touch wheel to navigate in an rightward (+X) direction within the two-dimensional object. Alternatively, to initiate navigation along the X axis in a −X direction, the second touch gesture can be initiated at a right position on the touch sensitive interface and advancing the touch gesture in either a clockwise or a counterclockwise motion on the touch sensitive interface to navigate in a leftward (−X) direction within the two-dimensional object. Using either a left or right starting location, once a navigation direction is selected along the X axis, a reversal of circular gesture results in a reversal of direction of navigation in the grid object. Thus, navigation in a first axis and subsequent navigation in a second axis can be accomplished using the aspects of the invention.

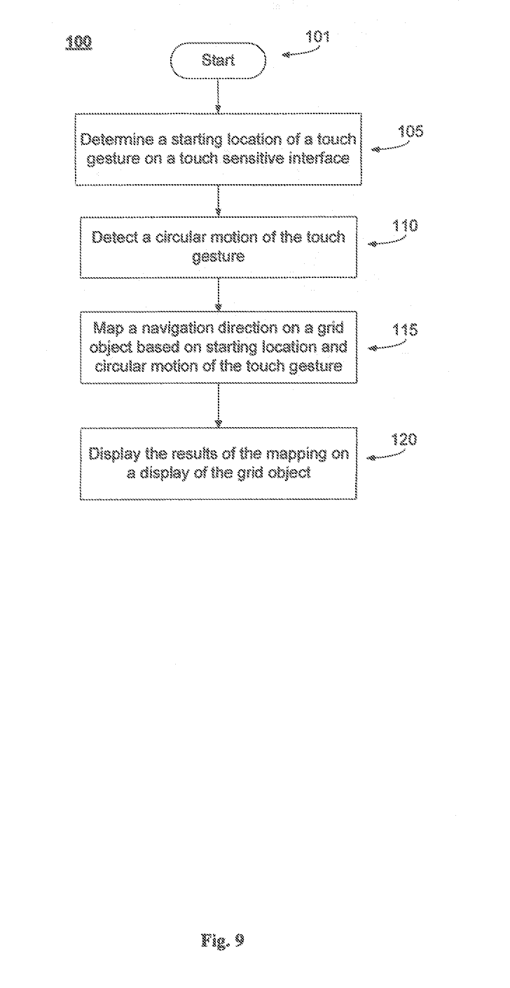

FIG. 9 depicts a method 100 according to the invention which encompasses both the first embodiment described using FIGS. 1-4 and the second embodiment described using FIGS. 5-8. The method of FIG. 9 begins at step 101 and moves to step 105 where an electronic device having a touch sensitive interface is used. The electronic device determines a starting location of a touch gesture on the touch sensitive interface. At step 110, movement along the touch sensitive interface causes the electronic device to detect a circular motion of the touch gesture. As expressed earlier, a linear gesture movement followed by a circular movement can also be detected as a circular gesture. At step 115, the electronic device then maps a navigation direction onto an object. The object may be a one dimensional object, such as a list, or a grid object. For descriptive purposes, a grid object is discussed below, but the invention functions well on a one dimensional list as well as a two dimensional grid object. Such a grid object may be any of an item such as a spreadsheet (matrix of cells), a graph, a text document, or a picture displayed on an electronic device. The results of the mapping are a movement within the grid object such that navigation within the grid object is achieved corresponding to the circular motion. It is noted that the movement within the grid object can be characterized as a horizontal movement (+X or −X axis) or a vertical movement (+Y or −Y axis), and the horizontal or vertical movement within the grid object is caused by a circular movement of a touch on the touch sensitive interface. Thus, at step 120, the resulting mapping of the circular movement to a horizontal or vertical movement within the grid object is displayed on a display device. This display enables a navigation of a two-dimensional grid object by a circular motion.

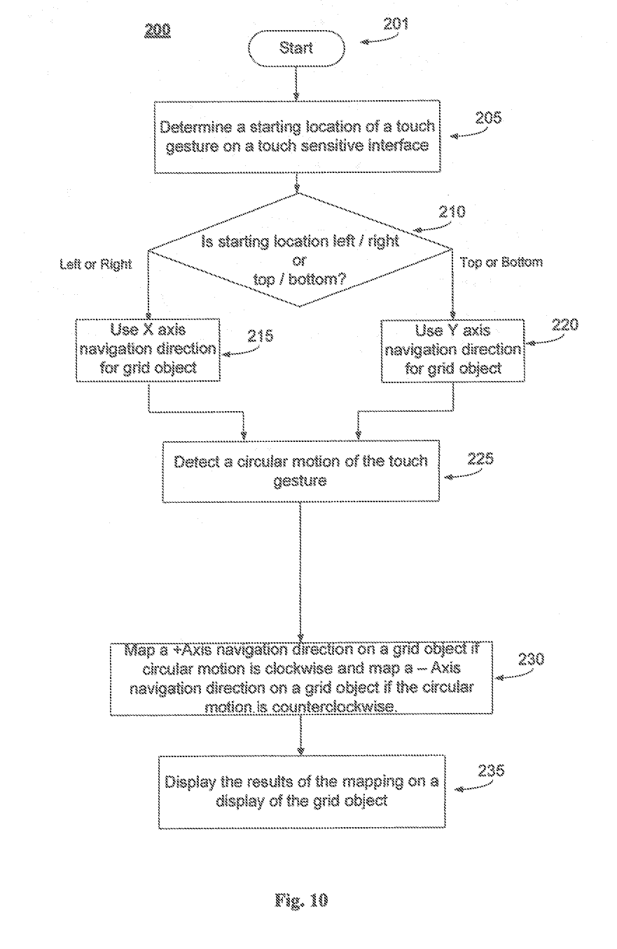

FIG. 10 depicts a first detailed embodiment method 200 of the FIG. 9 overall method 100. The method 200 of FIG. 10 corresponds to the actions of FIGS. 1-4. The method 200 starts at step 201 and moves to step 205 where an electronic device having a touch sensitive interface is used. The electronic device determines a starting location of a touch gesture on the touch sensitive interface. It is noted that the starting location of a circular touch gesture can occur anywhere on the touch sensitive interface. For example, a circular touch gesture could start in the center of the touch sensitive interface and the circular touch gesture would still be detected. At step 210, it is determined whether the starting location of the touch gesture is to the left or right of the center of the touch gesture on the touch sensitive interface. Alternately, it is determined whether the starting location of the touch gesture is to the top or bottom on the touch sensitive interface.

If the starting location of a touch on the touch sensitive interface is either at a left position or a right position around the center of a circular touch gesture, the starting position would indicate a determination that X axis navigation within the grid object is desired. This is as shown in FIGS. 1 and 2. Returning to FIG. 10, if the starting location of the touch on the touch sensitive interface is determined to be in the X direction, then step 215 is entered where an X axis navigation direction for movement within the grid object is used.

If the starting location of a touch on the touch sensitive interface is either at a top position or a bottom position around the center of a circular touch gesture, the starting position would be indicative of a determination that Y axis navigation within the grid object is desired. This is as shown in FIGS. 3 and 4. Returning to FIG. 10, if the starting location of the touch on the touch sensitive interface is determined to not be in the X direction, then step 215 is entered where a Y axis navigation direction for movement within the grid object is used.

In either event, the method 200 moves to step 225 where the electronic device detects a circular motion of the touch gesture on the touch sensitive interface. As express earlier, a linear gesture followed by a circular gesture can be interpreted as a circular gesture. At step 230, if a circular clockwise motion is detected on the touch sensitive interface, then a + axis navigation direction on a grid object is mapped onto the grid object. If a circular counterclockwise motion is detected on the touch sensitive interface, then a − axis navigation direction on a grid object is mapped onto the grid object. For example, if the determination at step 210 was that an X axis direction is to be mapped, then, at step 230, a clockwise circular motion would provide a +X navigation direction in the grid object. Also, if an X axis determination was made at step 210, and a counterclockwise circular motion were detected on the touch sensitive interface, then the electronic device would determine that a −X navigation direction would be mapped to the grid object. One of skill in the art would easily recognize that such definitions could be reversed without changing the basic function of the invention. That is, the invention could also be implemented such that a clockwise circular motion on the touch sensitive interface could also be mapped to a −X axis movement in the grid object.

At step 235, the results of the mapping of step 230 are displayed on a display device such that navigation within the grid object is achieved by viewing the display. In one aspect of the invention, if the touch gesture is uninterrupted (continuous) but a change of circular gesture rotation is detected on the touch sensitive interface by the electronic device, such as by changing from a clockwise to a counterclockwise rotation, then the electronic device would map the change of direction to be a reversal of the direction of mapping along the selected axis. For example, if the mapping and navigation were along the +X axis with a clockwise direction, and a change of rotation to a counterclockwise rotation occurred, then a change of mapping from a +X axis navigation to a −X axis navigation would occur. Such a reversal along a single axis can occur if the touch is continuous and uninterrupted.

In another aspect of the invention, after a desired X axis navigation occurred, a subsequent Y axis navigation can occur after the touch gesture is stopped by removing the touch from the touch sensitive interface. Then method 200 can be started again such that Y axis navigation could occur by selecting a different starting location such that steps 210 and 220 occurred. Then navigation in the Y axis would be achieved after X-axis navigation. Thus, navigation in a two-dimensional grid object using a circular touch sensitive interface can be achieved.

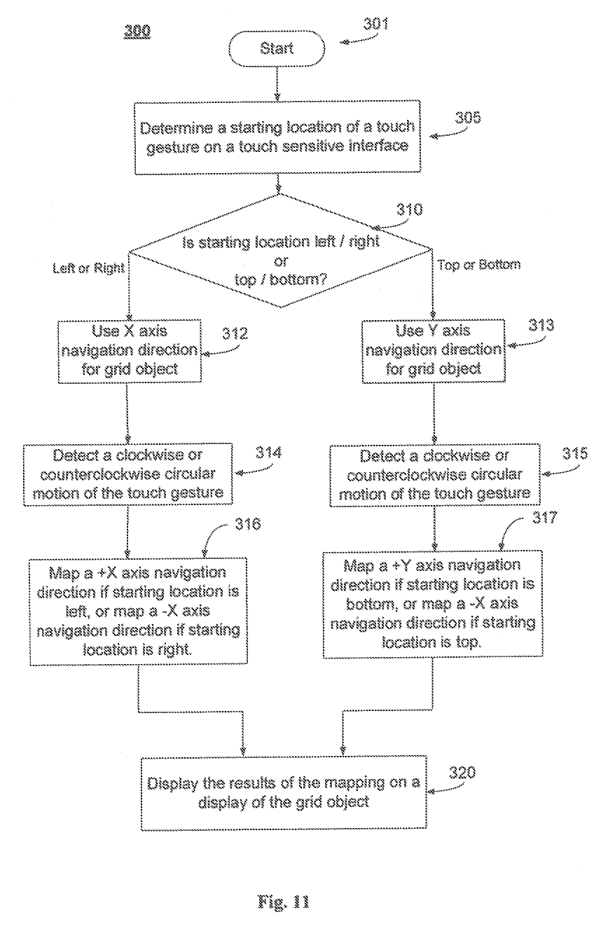

FIG. 11 depicts a method 300 and is a second embodiment of the FIG. 9 method 100. The method 300 of FIG. 11 corresponds to the actions of FIGS. 5-8. The method 300 starts at step 301 and moves to step 305 where an electronic device having a touch sensitive interface is used. The electronic device determines a starting location of a touch gesture on the touch sensitive interface. At step 310, it is determined whether the starting location of the touch gesture is to the left or right around the center of a circular touch gesture on the touch sensitive interface. Alternately, it is determined whether the starting location of the touch gesture is to the top or bottom around the center of a circular touch gesture on the touch sensitive interface.

If the starting location of a touch on the touch sensitive interface is either at a left position or a right position around the center of a circular touch gesture of the touch sensitive interface, then the starting position would indicate a determination that X axis navigation within the grid object is desired. As such, step 312 is entered where an X axis navigation direction for movement within the grid object is used. At step 314, a clockwise or a counterclockwise circular motion direction of the touch gesture is detected. As expressed earlier, the circular motion can be a purely or strictly circular motion, or it can be a linear gesture followed by a circular gesture. At step 316, a +X axis navigation direction is mapped to the grid object if the starting location of step 310 is to the left on the touch sensitive interface. Also at step 316, a −X axis navigation direction is mapped to the grid object if the starting location of step 310 is to the right on the touch sensitive interface.

Returning to step 310, if the starting location of a touch on the touch sensitive interface is either at a top position or a bottom position around the center of a circular touch gesture of the touch sensitive interface, then the starting position would indicate a determination that Y axis navigation within the grid object is desired. As such, step 313 is entered where a Y axis navigation direction for movement within the grid object is determined. At step 315, a clockwise or a counterclockwise circular motion direction of the touch gesture is detected. As expressed earlier, the circular motion can be a purely or strictly circular motion, or it can be a linear gesture followed by a circular gesture. At step 317, a +Y axis navigation direction is mapped to the grid object if the starting location of step 310 is to the bottom around the center of a circular touch gesture on the touch sensitive interface. Also at step 317, a −Y axis navigation direction is mapped to the grid object if the starting location of step 310 is to the top around the center of a circular touch gesture on the touch sensitive interface.

One of skill in the art would easily recognize that the direction definitions for steps 316 and 317 could be reversed without changing the basic function of the invention. However, it is reasonable to attempt to make the mapping from a circular motion to grid navigation as natural and intuitive as possible. The present implementation of the invention attempts to achieve that goal.

Returning to method 300, once a mapping of the circular gesture to a grid navigation direction is accomplished, for example, from step 316 or step 317, then step 320 is entered. At step 320, the mapping of the circular gesture to the grid navigation is displayed such that a two dimensional navigation may be achieved.

In another aspect of the invention, after a desired X axis navigation occurred, a subsequent Y axis navigation can occur after the touch gesture is stopped by removing the touch from the touch sensitive interface. Then method 300 can be started again such that Y axis navigation could occur by selecting a different starting location at step 305. Then navigation in the Y axis would be achieved after an X-axis navigation. Thus, navigation in a two-dimensional grid object using a circular touch sensitive interface can be achieved.

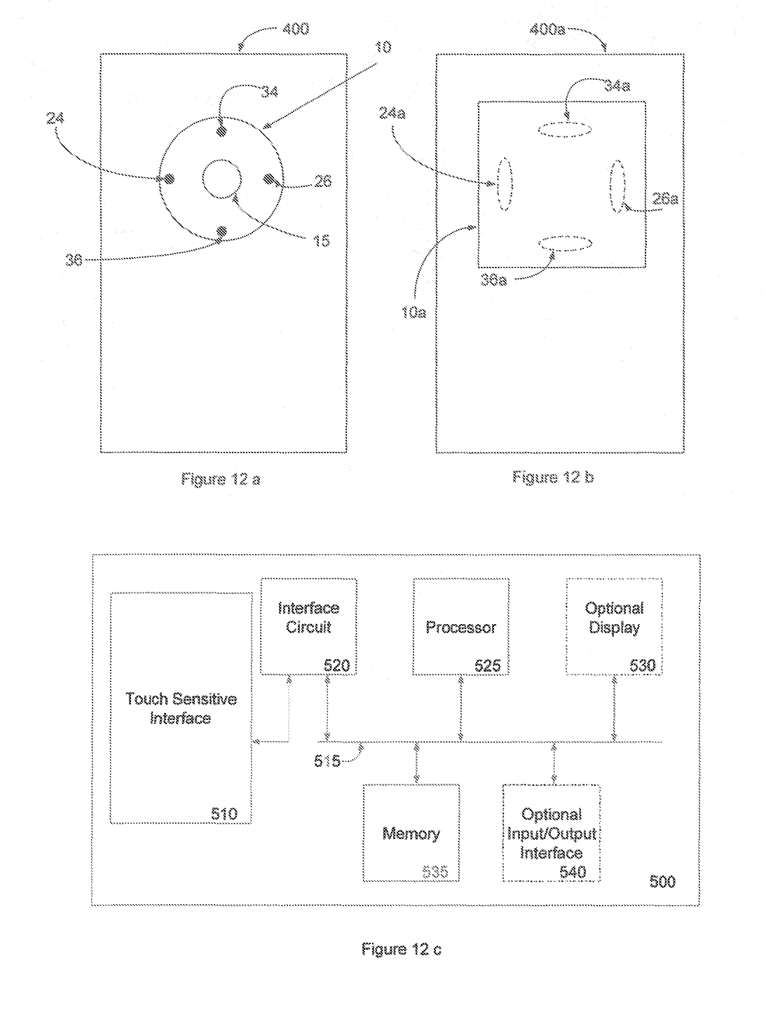

FIG. 12a depicts an electronic device 400 in one possible embodiment of the invention that uses a circular style touch sensitive interface. This interface is instructive to describe the relative locations of starting points of a touch gesture. As mentioned above, an electronic device that contains a touch sensitive interface need not also include the device that displays the grid object. Examples include a remote control device that contains a touch sensitive interface but controls a different electronic device that contains a remote display of the grid object. As shown in FIG. 12a, a circular touch sensitive interface 10 is shown as organized around a center reference area 15. The center reference area 15 is shown only for reference and may or may not have any particular relevance to any function of the touch sensitive interface 10. In this embodiment, a top location 34 is shown above a bottom location 36 around the center of a circular touch gesture. A left location 24 is shown to the left of a right location 26 around the center of a circular touch gesture. These locations provide the areas for navigation referred to in earlier descriptions.

In another possible embodiment of the invention, the touch sensitive interface is a touch pad interface as shown in FIG. 12b. Here, a top location 34a is considered above a bottom location 36a around the center of a circular touch gesture. A left location 24a is shown to the left of a right location 26a around the center of a circular touch gesture. The top 34a, bottom 36a, left 24a, and right 26a locations are shown relative to a center portion of a circular touch gesture. Also, in another aspect of the invention, the top, bottom, left, and right locations on the touch pad interface are shown as areas. It can be easily understood that a touch sensitive interface, such as a touch pad, touch screen, or circular touch sensitive interface, can easily contain more than one distinct point that may be interpreted as a starting location For the circular gesture. The starting location is relative to the center of a circular gesture. An area-type interpretation of a location starting location can apply to any touch sensitive interface including the interfaces depicted in FIGS. 12a and 12b.

FIG. 12c depicts an electronic device 500 block diagram that embody aspects of the invention. Included in the device 500 are a touch sensitive interface, such as the touch sensitive interface 510 shown in FIG. 12c, an interface circuit 520, a processor 525, an optional display 530, a memory 535, and an optional input/output interface for the device. The interface circuit 520 is an interface to the touch sensitive interface that can detect a touch action. In one embodiment, an internal bus 515 may be used to communicate detected touches from the interface circuit to the processor 525. The processor 525 can receive touch location information from interface circuit 520 and interpret that information. The processor 525 is useful to perform the methods described above and access memory 535 for program and data storage purposes. Memory 535 may also be used to supply optional display 530 with information relative to a displayable grid object and navigation of an X and Y axis of the grid object. Optional display 530 may be included where device 500 is for example, a handheld video device, a laptop or a tablet PC. However, optional display need not be included if device 500 is a remote control without a display. Optional input/output interface 540 may be included if device 500 is a remote control. In this instance, the input/output interface may be an RF or infrared port for remote control purposes. As is well understood by those of skill in the art, optional display and optional input/output interface may both be included if device 500 is a laptop or tablet computing device which can also be used for remote control purposes.

As is well understood by those of skill in the art, FIG. 12c represents only one possible implementation of the electronic device described above. Other implementations are possible including non-bus based implementations. One possible non-bused based implementation may be a combinatorial logic based implementation that could reduce or eliminate the need for a more sophisticated processor and memory. Another possible implementation can be a modular approach that allows use of the invention as a functional module in a larger instrument still having aspects of the invention.

The implementations described herein may be implemented in, for example, a method or process, an apparatus, or a combination of hardware and software. Even if only discussed in the context of a single form of implementation (for example, discussed only as a method), the implementation of features discussed may also be implemented in other forms (for example, a hardware apparatus, hardware and software apparatus, or a computer-readable media). An apparatus may be implemented in, for example, appropriate hardware, software, and firmware. The methods may be implemented in, for example, an apparatus such as, for example, a processor, which refers to any processing device, including, for example, a computer, a microprocessor, an integrated circuit, or a programmable logic device. Processing devices also include communication devices, such as, for example, computers, cell phones, portable/personal digital assistants (“PDAs”), and other devices that facilitate communication of information between end-users.

Additionally, the methods may be implemented by instructions being performed by a processor, and such instructions may be stored on a processor or computer-readable media such as, for example, an integrated circuit, a software carrier or other storage device such as, for example, a hard disk, a compact diskette, a random access memory (“RAM”), a read-only memory (“ROM”) or any other magnetic, optical, or solid state media. The instructions may form an application program tangibly embodied on a computer-readable medium such as any of the media listed above. As should be clear, a processor may include, as part of the processor unit, a computer-readable media having, for example, instructions for carrying out a process. The instructions, corresponding to the method of the present invention, when executed, can transform a general purpose computer into a specific machine that performs the methods of the present invention.

1. A method for navigation within an object displayed on an electronic device, the method comprising:
determining a starting location and a circular motion of a touch gesture on the touch sensitive interface;
mapping a navigation direction within the object based on the starting location and the circular direction of the touch gesture; and
displaying results of the navigation direction within the object.

2. The method of claim 1, wherein the object is a grid object and comprises any of a matrix of cells, a graph, a text document, or a picture displayed on the electronic device.

3. The method of claim 1, wherein the touch sensitive interface is a touch pad or touch screen device.

4. The method of claim 1, wherein:
the object is a grid object and the touch gesture comprises touching at either a top position or a bottom position on the touch sensitive interface and moving in the circular motion on the touch sensitive interface; and
the step of mapping a navigation direction within the grid object comprises transforming the touch gesture into a navigation direction along a Y axis within the grid object;
wherein subsequently reversing the circular motion of the touch gesture results in a reversal of the direction along the Y axis within the grid object.

5. The method of claim 4 wherein the circular motion is a clockwise motion and the direction along the Y axis is an upward (+Y) direction within the grid object.

6. The method of claim 1, wherein;
the object is a grid object and the touch gesture comprises touching at either a left position or a right position on the touch sensitive interface and moving in the circular motion on the touch sensitive interface; and
the step of mapping a navigation direction within the grid object comprises transforming the touch gesture into a navigation direction along an X axis within the grid object;
wherein subsequently reversing the circular motion of the touch gesture results in a reversal of the direction along the X axis.

7. The method of claim 6 wherein the circular motion is a clockwise motion and the direction along the X axis is a rightward (+X) direction within the grid object.

8. The method according to claim 1, wherein the object is a grid object and the navigation direction within the grid object is determined by the starting location, and wherein the circular motion of the touch gesture on the touch sensitive interface determines an initial circular motion that is mapped into the navigation direction.

9. The method of claim 8, wherein if the initial circular motion is subsequently reversed, then the navigation direction mapped onto the grid object is reversed.

10. The method of claim 1, wherein the object is a grid object and the touch gesture comprises:
touching at a top position of the circular gesture and moving in either a clockwise or a counterclockwise motion on the touch sensitive interface to navigate in a downward (−Y) direction within the grid object; or
touching at a bottom position of the circular gesture and moving in either a clockwise or a counterclockwise motion on the touch sensitive interface to navigate in an upward (+Y) direction within the grid object.

11. The method of claim 10, wherein a reversal of navigation direction from a downward (−Y) direction to an upward (+Y) direction and vice versa results when a rotational motion on the touch sensitive interface is reversed.

12. The method of claim 1, wherein the object is a grid object and the touch gesture comprises:
touching at a left position of the circular gesture and moving in either a clockwise or a counterclockwise motion on the touch sensitive interface to navigate in a rightward (+X) direction within the grid object; or
touching at a right position of the circular gesture and moving in either a clockwise or a counterclockwise motion on the touch sensitive interface to navigate in a leftward (−X) direction within the grid object.

13. The method of claim 12, wherein a reversal of navigation direction from a leftward (−X) direction to a rightward (+X) direction and vice versa results when a rotational motion on the touch sensitive interface is reversed.

14. An electronic apparatus the electronic apparatus comprising:
a touch sensitive interface which detects a starting location of a circular touch gesture;
a processor which uses the starting location of the detected circular touch gesture to map the circular touch gesture onto one axis of a grid object having X and Y axis of information, wherein the processor maps advancement of the circular touch gesture to movement along one of the X or the Y axis of the grid object.

15. An electronic apparatus the electronic apparatus comprising:
a touch sensitive interface comprising a touch pad or touch screen which detects a circular touch gesture;
a processor which maps the detected circular touch gesture into a continuous navigation of a displayed list of items.
